(19) United States
(12) Patent Application Publication
(10) Pub. No.: US 2007/0189528 A1
(43) Pub. Date: Aug. 16, 2007

(54) Wireless LAN transmitting and receiving apparatus and key distribution method

(76) Inventor: Yutaka Ueda, Chiba (JP)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/605,975

(22) Filed: Nov. 30, 2006

(30) Foreign Application Priority Data
Feb. 14, 2006 (JP) 2006-036158

(51) Int. Cl. H04L 9/00

(52) U.S. Cl. 380/44

(57) ABSTRACT

Two stations in a wireless local area network generate a key from a shared key by generating respective proprietary random numbers, using the shared key to encrypt the proprietary random numbers, sending each other the encrypted proprietary random numbers, using the shared key to decrypt the encrypted proprietary random numbers, and then combining both proprietary random numbers with part of the shared key. The generated key is then used to encrypt and decrypt data sent between the two stations. Exchanging the proprietary random numbers in an encrypted form enhances the security of the generated key.

### BACKGROUND OF THE INVENTION

1. Field of the Invention

The present invention relates to a transmitting and receiving apparatus and key distribution method for a wireless local area network (LAN), and in particular to a method of distributing an encryption key in a wireless LAN conforming to standard 802.11il of the Institute of Electrical and Electronics Engineers (IEEE).

2. Description of the Related Art

IEEE standard 802.11il, which provides enhanced security for wireless LAN apparatus complying with the IEEE 802.11 family of standards, incorporates both the pre-existing wired equivalent privacy (WEP) protocol defined in the older IEEE 802.11 standards and two new encryption protocols: a temporal key integrity protocol (TKIP), and a counter-mode cipher-block-chaining message-authentication-code protocol (also known as the CTR with CBC-MAC protocol, or more briefly as CCMP). It also provides a key distribution procedure known as a four-way handshake in which an access point and a client station in a wireless LAN can establish a shared encryption key by using an already shared pairwise master key and a pair of proprietary random numbers. The proprietary random numbers are referred to as ‘nonces’, meaning that they are numbers that are used only once.

The access point initiates the four-way handshake by sending the client station a message including a nonce known as an ANonce. Upon receiving this first message, the client station generates another nonce, known as an SNonce, and sends it in a second message to the access point. The access point and client station then use the ANonce and SNonce and the shared pairwise master key, which they acquired in a preceding authentication procedure, to generate an encryption key. After exchanging two more messages that complete the four-way handshake, the access point and client station are ready to use the newly generated encryption key to encrypt and decrypt wireless traffic transmitted between them.

A weakness in this four-way handshake procedure is that the random numbers ANonce and SNonce are sent in an unprotected form and can easily be intercepted by an eavesdropper. Although this does not immediately enable the eavesdropper to reconstruct the encryption key, because the eavesdropper is not in possession of the pairwise master key, knowledge of the ANonce and SNonce values may assist the eavesdropper in cryptanalysis of subsequent data traffic, increasing the likelihood that the eavesdropper will be able to decrypt the data traffic.

Japanese Patent Application Publication No. 2001-111543 discloses an encryption key distribution method based on the conventional IEEE 802.11 standard, in which keys are managed and updated by a central server.

### SUMMARY OF THE INVENTION

A general object of the present invention is to increase the security of data traffic in a wireless LAN.

A more specific object is to enable two stations in a wireless LAN to exchange a pair of random numbers, from which they derive an encryption key, without enabling an eavesdropper to learn the random numbers.

The invention provides a transmitting and receiving apparatus for use in a wireless LAN. The transmitting and receiving apparatus is used in an access point and a client station that employ an encryption key generated from an authenticated shared key and a pair of proprietary random numbers to encrypt and decrypt transmitted and received data.

A message assembling circuit in the wireless LAN transmitting and receiving apparatus generates a first random number, uses the shared key to transform the first random number, and places the transformed first random number in an outgoing message.

A message disassembling circuit in the wireless LAN transmitting and receiving apparatus receives an incoming message including a transformed second random number, extracts the transformed second random number, and uses the shared key to recover a second random number from the transformed second random number.

The first random number and the second random number constitute the pair of proprietary random numbers that the access point and client station use in generating the encryption key.

An eavesdropper intercepting the transformed random numbers but not in possession of the shared key will be unable to recover the first and second random numbers. Concealing the first and second random numbers in this way makes cryptographic attacks on subsequent data traffic between the access point and client station more difficult.

### BRIEF DESCRIPTION OF THE DRAWINGS

In the attached drawings:

FIG. 1 illustrates a wireless LAN configuration;

FIG. 2 illustrates a four-way handshake procedure;

FIG. 3 illustrates a message format used in the four-way handshake procedure;

FIG. 4 is a block diagram of a message assembling circuit in a first embodiment of the invention;

FIG. 5 is a block diagram of a message disassembling circuit in the first embodiment;

FIG. 6 is a block diagram of a message assembling circuit in a second embodiment of the invention; and

FIG. 7 is a block diagram of a message disassembling circuit in the second embodiment.

### DETAILED DESCRIPTION OF THE INVENTION

Embodiments of the invention will now be described with reference to the attached drawings, in which like elements are indicated by like reference characters.

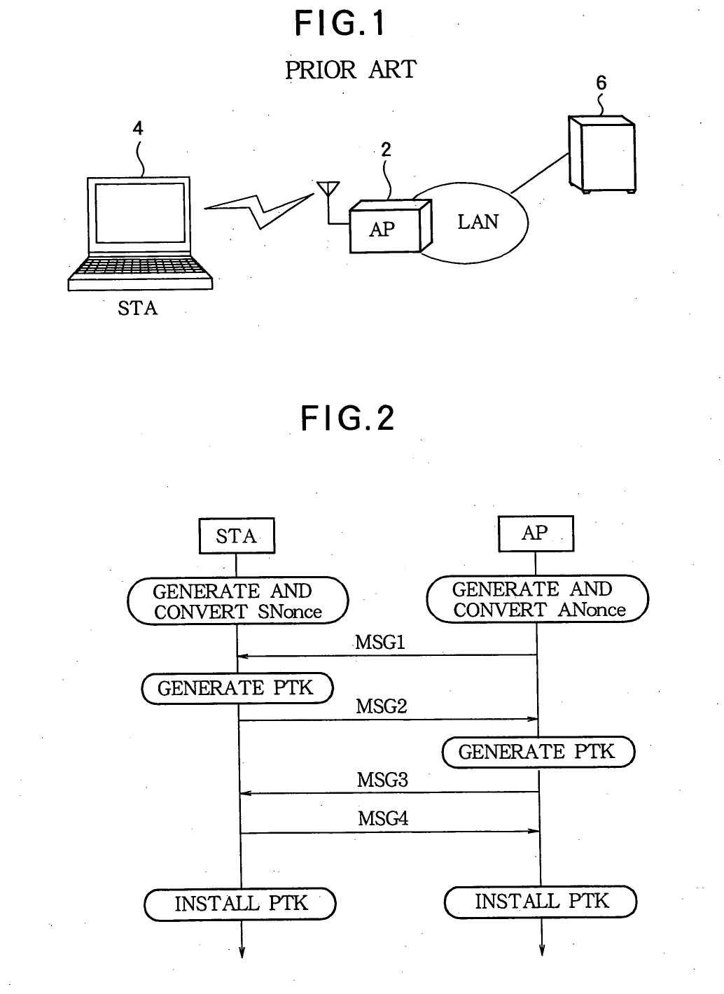

The embodiments assume a conventional LAN configuration of the type illustrated schematically in FIG. 1. An access point (AP) 2 conducts wireless communication with a client station (STA) 4, and communicates over a wired network with an authentication server 6. The authentication server 6 uses an authentication protocol defined in the IEEE 802.1X standard to authenticate the client station 4 to the access point 2. In the authentication process, the access point 2 and client station 4 acquire a 256-bit shared pairwise master key (PMK) not possessed by other access points or client stations (not shown). The PMK acquisition procedure is well known and will not be described in detail, save to note that it is carried out by an extensible authentication protocol (EAP) that is executed in a layer higher than the media access control (MAC) layer in the protocol stack by which the LAN operates.

Following the authentication procedure, the access point 2 and client station 4 execute a four-way handshake substantially conforming to the IEEE 802.11il standard, in which they use the shared PMK to generate other keys for use in encrypting subsequent data traffic. The four-way handshake procedure is illustrated in FIG. 2. First, access point 2 and client station 4 generate respective proprietary 256-bit random numbers ANonce and SNonce and transform them as described later. Access point 2 places the transformed ANonce in a first message MSG1 that it sends to client station 4. Client station 4 reversely transforms the transformed ANonce to obtain the original ANonce, uses ANonce, SNonce, and the pairwise master key PMK to generate a pairwise transient key (PTK), and sends SNonce to access point 2 in a second message MSG2. Access point 2 reversely transforms the transformed SNonce to obtain the original SNonce, and uses ANonce, SNonce, and the pairwise master key PMK to generate the same pairwise transient key (PTK). Access point 2 also sends client station 4 a third message (MSG3) including a message integrity checksum (MIC) generated with the PTK. If client station 4 receives this third message correctly it sends access point 2 a fourth message (MSG4) in acknowledgement, and both access point 2 and client station 4 proceed to install the PTK value in the apparatus (not shown) they will use for encrypting and decrypting further data traffic between them.

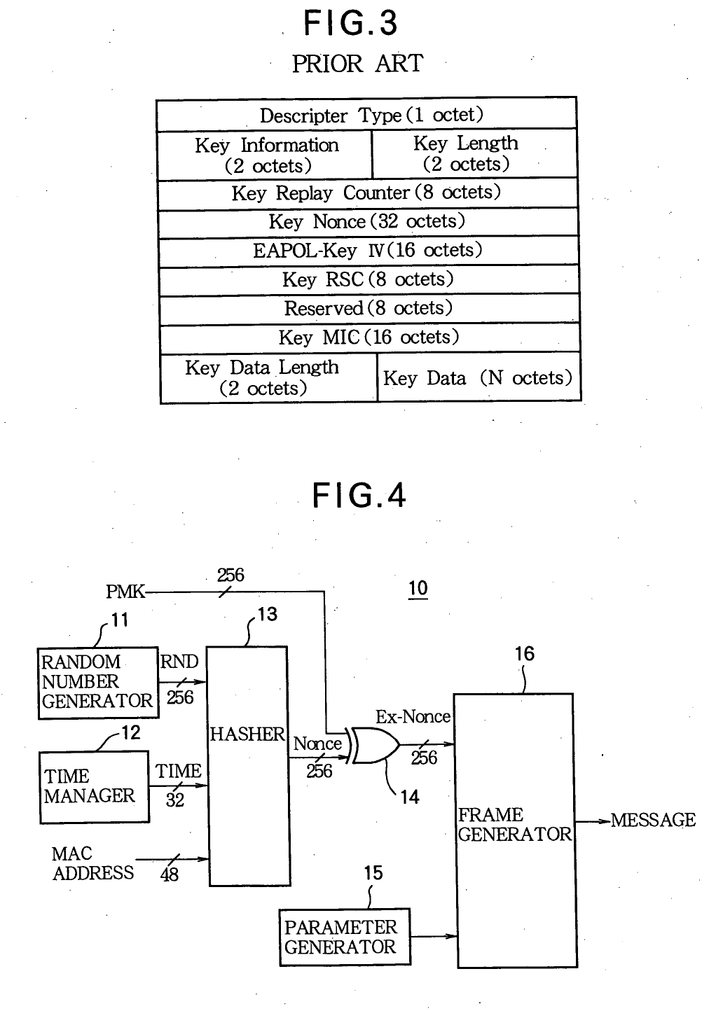

FIG. 3 shows the format of the message frames in which the four messages in FIG. 2 are sent. These frames are also referred to as EAP-over-LAN-Key frames (EAPOL-Key frames). ANonce and SNonce are conventionally placed as-is in the Key Nonce field. The present invention differs from the conventional art in that ANonce and SNonce are transformed and the transformed values are placed in the Key Nonce field. Exemplary transformations are described in the embodiments below.

The Key RSC field in FIG. 3, incidentally, contains a key receive sequence counter value.

### First Embodiment

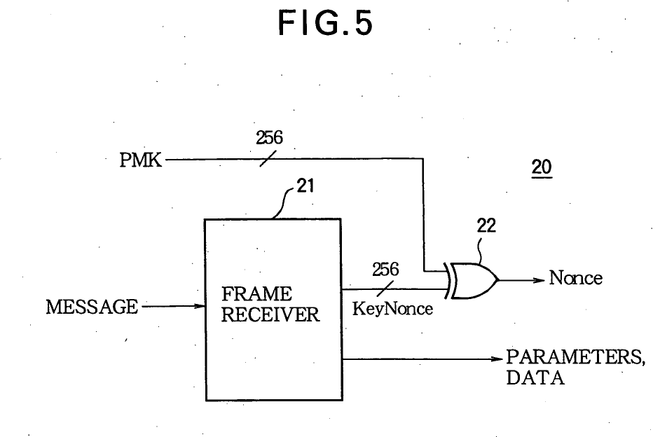

FIGS. 4 and 5 illustrate the structure of a message processing circuit used at both the access point 2 and the client station 4 in a first embodiment of the invention. FIG. 4 shows a message assembling circuit that operates when a message is transmitted in the four-way handshake. FIG. 5 shows a message disassembling circuit that operates when a message is received in the four-way handshake. The message processing circuit includes both of these circuits.

In the following description, the term ‘Nonce’ will be used to denote a random number that may be either ANonce or SNonce, depending on which message in the handshake procedure is being processed.

The message assembling circuit 10 in FIG. 4 comprises a random number generator 11, a time management unit 12, a hasher 13, an exclusive-OR circuit 14, a parameter generator 15, and a frame generator 16.

The random number generator 11 generates a 256-bit pseudorandom number RND.

The time management unit 12 outputs 32-bit current time information (TIME) in the network time protocol (NTP) format defined by Request for Comments (RFC) 1305 of the Internet Engineering Task Force (IETF).

The hasher 13 receives the pseudorandom number RND, the current time information, and the 48-bit MAC address of the access point or client station in which the message assembling circuit 10 resides (the local MAC address) and generates a hashed 256-bit random number Nonce according to a formula defined in the IEEE 802.111 standard.

The exclusive-OR circuit 14 receives the 256-bit random number Nonce and the 256-bit pairwise master key PMK shared by the access point 2 and client station 4, takes their bit-wise exclusive logical OR, and outputs the result as a 256-bit transformed random number EX-Nonce to the frame generator 16.

The parameter generator 15 generates all of the parameters and data shown in FIG. 3 other than the value of the Key-Nonce field. A detailed description of these parameters and data will be omitted. The frame generator 16 places the transformed random number EX-Nonce received from the exclusive-OR circuit 14 in the Key-Nonce field and the parameters and data received from the parameter generator 15 in the other fields in FIG. 3.

The message disassembling circuit 20 in FIG. 5 comprises a frame receiver 21 and an exclusive-OR circuit 22. The frame receiver 21 inputs a received message frame having the format shown in FIG. 3 and separates the value of the Key Nonce field from the other parameters and data. The value of the Key Nonce field is supplied to the exclusive-OR circuit 22, together with the shared pairwise master key PMK. The exclusive-OR circuit 22 takes the exclusive logical OR of the 256-bit value of the Key Nonce field and the 256-bit shared PMK to recover a 256-bit random number Nonce.

Next, the operation of the first embodiment will be described.

In the message assembling circuit 10 in FIG. 4, the hasher 13 applies a pseudorandom function to the 256-bit pseudorandom number RND generated by the random number generator 11, the 48-bit local MAC address, and the 32-bit current time information output by the time management unit 12 to produce the 256-bit random number Nonce. The pseudorandom function will be denoted PRF-256. Nonce is generated according to the following formula:
Nonce PRF-256(RND,“Init Counter”,Local-MAC-Address∥TIME)

“Init Counter” is a fixed character string. The ‘∥’ symbol indicates concatenation. TIME is the 32-bit current time information output by the time management unit 12.

This pseudorandom function PRF-256 is an instance of a more general pseudorandom function PRF-X that generates an X-bit number. PRF-X is a keyed hash message authentication code (HMAC) function that uses a so-called secure hash algorithm (SHA-1); this combination is referred to as HMAC-SHA-1. PRF-X is defined as follows in terms of HMAC-SHA-1:

PRF-X(K, A, B)

for i [symbol] 0 to (X + 159) /160 do

R [symbol] R | | H-SHA-1 (K, A, B, X)

Return L(R, 0, X)

H-SHA-1(K, A, B, X) [symbol] HMAC-SHA-1 (K, A | | 0x00000000

| | B | | X)

In the operation performed by the hasher 13, the variables K, A, B, and X have the following values:

K=RND

A=“Init Counter” (fixed character string)

B=Local-MAC-Address∥TIME

X=256

The function L(R, 0, X) indicates that X bits are taken from bit sequence R, starting from the zeroth bit (the lowest bit). A full description of the well-known HMAC-SHA-1 algorithm will be omitted.

The 256-bit random number Nonce generated by the hasher 13 as described above is supplied to the exclusive-OR circuit 14, together with the 256-bit PMK. The exclusive-OR circuit 14 takes the bit-wise exclusive logical OR of the two supplied 256-bit numbers and outputs the 256-bit transformed value EX-Nonce.

The EX-Nonce value output from the exclusive-OR circuit 14 and other parameters and data output from the parameter generator 15 are supplied to the frame generator 16, which generates a message for transmission in the four-way handshake. This message has the EAPOL-Key frame format shown in FIG. 3, the 256-bit (32-octet) EX-Nonce value being placed in the Key Nonce field.

When this message is received by the message disassembling circuit 20 in FIG. 5, the frame receiver 21 extracts the transformed EX-Nonce value from the Key Nonce field, and extracts other parameters and data from the other fields. The exclusive-OR circuit 22 takes the bit-wise exclusive logical OR of EX-Nonce and the shared pairwise master key PMK to obtain the 256-bit random number Nonce that was generated by the hasher 13 in FIG. 4. The other parameters and data are supplied to relevant processing circuits (not shown).

After the above operations have been carried out to generate, transmit, and receive both ANonce and SNonce, the access point 2 and client station 4 generate the pairwise transient key PTK by the following formula:
PTK=PRF-X(PMK,“Pairwise Key expansion”,Min(AA,SPA)∥Max(AA,SPA)∥Min(ANonce,SNonce)∥Max(ANonce,SNonce))

PRF-X is the X-bit pseudorandom function explained above; the value of X is 512 when the TKIP protocol is used and 384 when the CCMP protocol is used. “Pairwise Key expansion” is a fixed character string, AA stands for authenticator address (the 48-bit MAC address of the access point 2), and SPA stands for supplicant address (the 48-bit MAC address of the address of the client station 4). Max and Min stand for maximum and minimum, respectively.

In the conventional art, two of the elements in this formula, namely ANonce and SNonce, are exposed to possible interception during the four-way handshake. In the first embodiment, none of the elements in this formula are exposed during the four-way handshake, since ANonce and SNonce are transformed to other values before being transmitted, and cannot be reconstructed by an eavesdropper who is not in possession of the pairwise master key PMK. The first embodiment therefore offers a higher degree of security than the conventional art.

### Second Embodiment

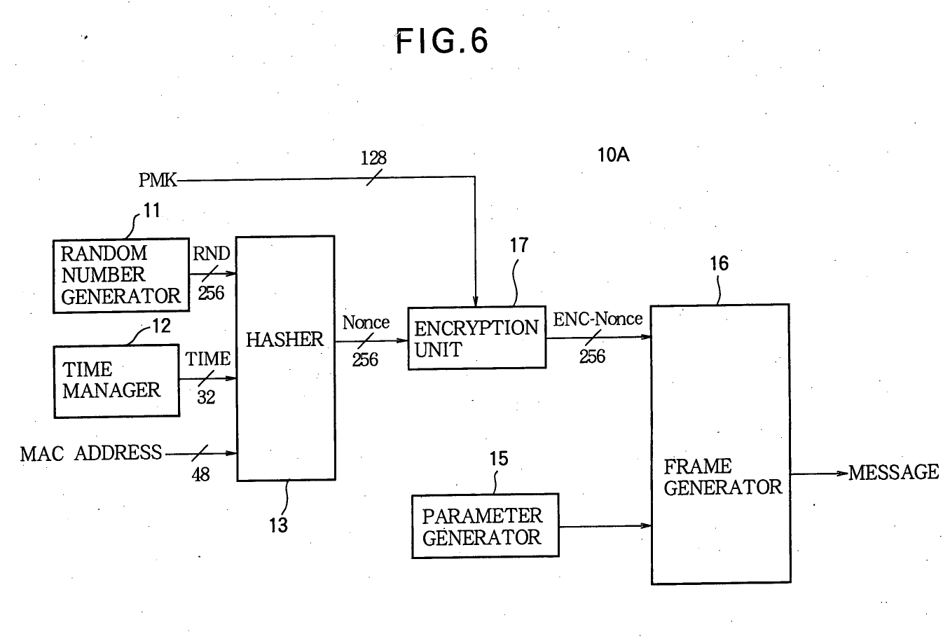

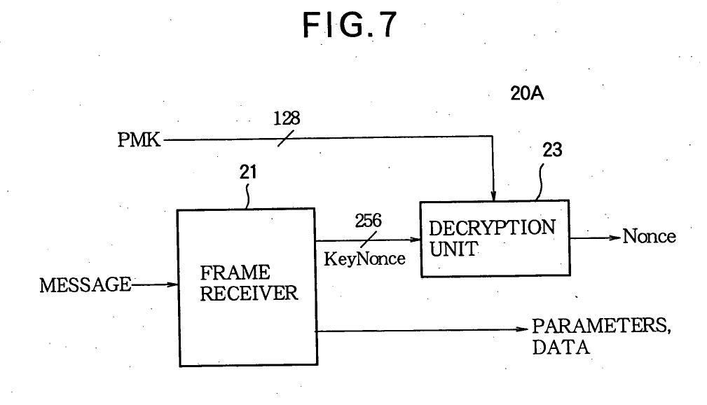

The second embodiment provides the message processing circuits shown in FIGS. 6 and 7.

Referring to FIG. 6, the message assembling circuit 10A in the second embodiment replaces the exclusive-OR circuit of the first embodiment with an encryption unit 17. The encryption unit 17 encrypts the 256-bit random number Nonce generated by the hasher 13 by the well-known ARC4 (Alleged Rivest Cipher 4) algorithm, using the lower 128 bits of the shared pairwise master key PMK, and outputs a 256-bit transformed random number ENC-Nonce. The other elements in FIG. 6 are similar to the corresponding elements in FIG. 4.

Referring to FIG. 7, the message disassembling circuit 20A in the second embodiment replaces the exclusive-OR circuit of the first embodiment with a decryption unit 23. The decryption unit 23 decrypts the value extracted from the ‘Key Nonce’ field of a received message frame, using the lower 128 bits of the shared pairwise master key PMK and the ARC4 method, to obtain the 256-bit random number Nonce. The other elements in FIG. 7 are similar to the corresponding elements in FIG. 5.

ARC4 is a well-known stream cipher that has been used in the WEP encryption scheme and in the secure socket layer (SSL) protocol. The SSL protocol has been widely used for security on the Internet. The maximum key length in the ARC4 algorithm is 128 bits.

Next, the operation of the second embodiment will be described.

In the message assembling circuit 10a in FIG. 6, the 256-bit random number RND generated by the random number generator 11 and the 32-bit current time information (TIME) output by the time management unit 12 are supplied to the hasher 13, which generates the random number Nonce as described in the first embodiment.

The 256-bit random number Nonce generated by the hasher 13 is supplied to the encryption unit 17. The encryption unit 17 executes the ARC4 algorithm, using the least significant 128 bits of the shared pairwise master key PMK, thereby transforms the 256-bit random number Nonce to a 256-bit encrypted random number ENC-Nonce, and outputs ENC-Nonce.

The transformed (encrypted) random number ENC-Nonce and other parameters and data output are supplied to the frame generator 16, which generates a message for transmission in the four-way handshake. The transformed random number ENC-Nonce is placed in the Key Nonce field in the message frame.

In the message disassembling circuit 20A in FIG. 7, the message frame received in the four-way handshake is input to the frame receiver 21, and the value of the Key Nonce field (the transformed random number ENC-Nonce) is extracted together with the other parameters and data. The transformed random number ENC-Nonce is input, together with the least significant 128 bits of the shared pairwise master key PMK, to the decryption unit 23, which decrypts the ENC-Nonce value to obtain the 256-bit random number Nonce. Other parameters and data are also extracted and supplied to relevant processing circuits (not shown).

The second embodiment provides essentially the same effects as the first embodiment by transmitting ANonce and SNonce in an encrypted form so that they are not exposed to eavesdropping during the four-way handshake. To the extent that the ARC4 encryption algorithm is more resistant than the exclusive-OR operation to cryptographic attacks, the second embodiment provides an even higher level of security than the first embodiment.

The invention is not limited to the foregoing embodiments. For example, the methods of transforming the random numbers ANonce and SNonce are not limited to the exclusive-OR method and the ARC4 algorithm; any suitable transformation based on the shared key may be used. The shared key need not be the PMK; any secret key possessed by both the access point 2 and the client station 4 may be used. The invention may be practiced in networks that, like the network described in Japanese Patent Application Publication No. 2001-111543, have many access points and client stations.

The invention has been described as being implemented in hardware circuits, but it may also be implemented in software, or a combination of hardware and software.

Those skilled in the art will recognize that further variations are possible within the scope of the invention, which is defined in the appended claims.

What is claimed is:

1. A wireless local area network (LAN) transmitting and receiving apparatus for use in a wireless LAN in which an access point and a client station use an encryption key generated from an authenticated shared key and a pair of proprietary random numbers to encrypt and decrypt transmitted and received data, the wireless LAN transmitting and receiving apparatus comprising:
a message assembling circuit for generating a first random number, using the shared key to transform the first random number, and placing the transformed first random number in an outgoing message frame; and
a message disassembling circuit for receiving an incoming message frame including a transformed second random number, extracting the transformed second random number, and using the shared key to recover a second random number from the transformed second random number;
the first random number and the second random number constituting the pair of proprietary random numbers.

2. The wireless LAN transmitting and receiving apparatus of claim 1, wherein:
the message assembling circuit generates the transformed first random number by performing an exclusive logical OR operation bit by bit on the first random number and the shared key; and
the message disassembling circuit recovers the second random number by performing an exclusive logical OR operation bit by bit on the received transformed second random number and the shared key.

3. The wireless LAN transmitting and receiving apparatus of claim 1, wherein:
the message assembling circuit generates the transformed first random number by using a portion of the shared key to encrypt the first random number; and
the message disassembling circuit recovers the second random number by using a portion of the shared key to decrypt the received transformed second random number.

4. A method of distributing a key in a wireless LAN in which an access point and a client station use an encryption key generated from an authenticated shared key and a pair of proprietary random numbers to encrypt and decrypt transmitted and received data, the method comprising:
generating a first random number at the access point and a second random number at the client station, the first random number and the second random number constituting the pair of proprietary random numbers;
transforming the first random number to a transformed first random number at the access point by using the shared key;
placing the transformed first random number in a first message;
sending the first message frame from the access point to the terminal;
transforming the second random number to a transformed second random number at the terminal by using the shared key;
placing the transformed second random number in a
second message;
sending the second message frame from the client
station to the access point;
receiving the first message at the client station;
extracting the transformed first random number from the second message at the client station;
recovering the first random number from the transformed first random number at the client station by using the shared key;
receiving the second message frame at the access point;
extracting the transformed second random number from the second message at the access point; and
recovering the second random number from the transformed second random number at the access point by using the shared key.

5. The method of claim 4, wherein:
transforming the first random number includes performing an exclusive logical OR operation bit by bit on the first random number and the shared key;
transforming the second random number includes performing an exclusive logical OR operation bit by bit on the second random number and the shared key;
recovering the first random number includes performing an exclusive logical OR operation bit by bit on the transformed first random number and the shared key; and
recovering the second random number includes performing an exclusive logical OR operation bit by bit on the transformed second random number and the shared key.

6. The method of claim 4, wherein:
transforming the first random number includes using a portion of the shared key to encrypt the first random number;
transforming the second random number includes using a portion of the shared key to encrypt the second random number;
recovering the first random number includes using a portion of the shared key to decrypt the transformed first random number; and
recovering the second random number includes using a portion of the shared key to decrypt the transformed second random number.

7. A method of distributing a key in a wireless LAN, comprising:
using a medium access control (MAC) address and time information to generate a proprietary random number;
using a shared key to encrypt the proprietary random number, thereby generating an encrypted random number;
placing the encrypted random number in a message; and
transmitting the message.

8. The method of claim 7, further comprising:
receiving the message;
extracting the encrypted random number from the
received message; and
using the shared key to decrypt the encrypted random number, thereby obtaining the proprietary random number.
